(19) United States
(12) Patent Application Publication
(10) Pub. No.: US 2024/0262654 A1
(43) Pub. Date: Aug. 8, 2024

(54) SOLUTION FOR RESETTING A SAFETY MODE OF AN ELEVATOR SYSTEM

(71) Applicant: KONE CORPORATION, Helsinki (FI)

(72) Inventors: Ari Jussila, Helsinki (FI); Toni Hirvonen, Helsinki (FI); Atso Koskinen, Helsinki (FI)

(73) Assignee: KONE CORPORATION, Helsinki (FI)

(21) Appl. No.: 18/595,709

(22) Filed: Mar. 5, 2024

Related U.S. Application Data
(63) Continuation of application No. PCT/EP2021/078879, filed on Oct. 19, 2021.

(51) Int. Cl. B66B 5/00; B66B 1/34

(52) U.S. Cl. CPC B66B 5/0056; B66B 1/3461; B66B 2201/406

(57) ABSTRACT

The invention relates to a method for resetting a safety mode of an elevator system. The safety mode is caused by a power cycle of the elevator system. The method comprises: obtaining, upon a restoration of a power supply of the elevator system, status information indicative of a current safety status of at least one safety space of the elevator system from an elevator safety detection system; receiving, from a remote elevator service entity, a reset command comprising an instruction to reset the safety mode of the elevator system; and resetting the safety mode of the elevator system in response to receiving the reset command, if the obtained status information fulfills a predefined criterion. The invention relates also to an elevator safety control unit, a remote reset system, a computer program, and a computer-readable storage medium for resetting a safety mode of an elevator system.

### TECHNICAL FIELD

The invention concerns in general the technical field of elevator systems. Especially the invention concerns safety of elevator systems.

### BACKGROUND

Typically, an elevator system comprises an elevator safety detection system, that detects, when safety personnel, e.g. a service technician, enters an elevator shaft of the elevator system. In that case the elevator system is turned into a person-in-shaft safety mode, in which the normal operation of the elevator system is prevented for safety reasons. When the elevator system is in the person-in-shaft safety mode, only a low-speed manual drive operation of an elevator car may be possible for the service technician working inside the elevator shaft, through a dedicated manual user interface provided therein.

After the service technician has left the elevator shaft, the service technician must perform a manual reset via an operating interface to recover the elevator system from the person-in-shaft safety mode. Only after that the normal operation of the elevator system will be restored.

The elevator safety detection system may be equipped with a backup power supply, to enable the safety detection in a power outage situation as well. Nevertheless, if a long enough power outage occurs, the elevator safety detection system runs out of power and shuts down, meaning that any consequent elevator shaft entrance by the service personnel or corresponding safety-related action remains unnoticed by the elevator safety detection system. Therefore, a visit of service personnel, e.g. the service technician, to the elevator system site is required before restoration of the normal operation of the elevator system. This is laborious, increases elevator system downtime and worsens elevator service.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an elevator safety control unit, a remote reset system, a computer program, and a computer-readable storage medium for resetting a safety mode of an elevator system. Another objective of the invention is that the method, the elevator safety control unit, the remote reset system, the computer program, and the computer-readable storage medium for resetting a safety mode of an elevator system enable a remote restoration of the elevator system from the safety mode.

The objectives of the invention are reached by a method, an elevator safety control unit, a remote reset system, a computer program, and a computer-readable storage medium as defined by the respective independent claims.

According to a first aspect, a method for resetting a safety mode of an elevator system is provided, wherein the safety mode is caused by a power cycle of the elevator system, wherein the method comprises: obtaining, upon a restoration of a power supply of the elevator system, status information indicative of a current safety status of at least one safety space of the elevator system from an elevator safety detection system; receiving, from a remote elevator service entity, a reset command comprising an instruction to reset the safety mode of the elevator system; and resetting the safety mode of the elevator system in response to receiving the reset command, if the obtained status information fulfills a predefined criterion.

The resetting the safety mode of the elevator system may comprise turning the elevator system from the safety mode into a limited operational mode, in which at least a limited operation of the elevator system may be allowed.

In the limited operational mode, a movement of an elevator car of the elevator system to a top floor a bottom floor, and/or at least one other floor may be prevented.

The method may comprise providing to the remote elevator service entity a reset request in response to determining that the obtained status information fulfills the predefined criterion, and receiving from the remote elevator service entity the reset command, in response to providing the reset request to the remote elevator service entity.

The reset request may comprise or may be complemented with the status information obtained from the elevator safety detection system.

The elevator safety detection system may comprise at least one imaging sensor device, at least sensor device, and/or a plurality of safety contacts.

The reset command may be a manual reset command issued manually in the remote elevator service entity.

The safety mode of the elevator system may comprise a person-in-shaft safety mode or a safety space arrangement (SSA) safety mode.

The predefined criterion may comprise that the at least one safety space of the elevator system is empty.

The power cycle may comprise a sequence of power events, wherein the sequence of the power events may comprise a power outage of the elevator system and the restoration of the power supply of the elevator system after the power outage.

The method may comprise setting the elevator system into the safety mode in response to detecting the power cycle of the elevator system.

According to a second aspect, an elevator safety control unit for resetting a safety mode of an elevator system is provided, wherein the safety mode is caused by a power cycle of the elevator system, the elevator safety control unit comprises: a processing unit comprising at least one processor; and a memory unit comprising at least one memory including computer program code; wherein the at least one memory and the computer program code are configured to, with the at least one processor, cause the elevator safety control unit to perform: obtain, upon a restoration of a power supply of the elevator system, status information indicative of a current safety status of at least one safety space of the elevator system from an elevator safety detection system; receive, from a remote elevator service entity, a reset command comprising an instruction to reset the safety mode of the elevator system; and reset the safety mode of the elevator system in response to receiving the reset command, if the obtained status information fulfills a predefined criterion.

According to a third aspect, a remote reset system for resetting a safety mode of an elevator system is provided, wherein the safety mode is caused by a power cycle of the elevator system, wherein the remote reset system comprises: an elevator safety detection system, a remote elevator service entity, and an elevator safety control unit as described above.

According to a fourth aspect, a computer program comprising instructions which, when the program is executed by a computer (e.g. the elevator safety control unit as describe above), cause the computer to carry out the method as described above.

According to a fifth aspect, a computer-readable storage medium comprising instructions which, when executed by a computer (e.g. the elevator safety control unit as describe above), cause the computer to carry out the method as described above.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system.

FIG. 2 illustrates schematically an example of a method for resetting a safety mode of an elevator system.

FIG. 3 illustrates schematically an example of components of an elevator safety control unit.

### DESCRIPTION OF THE EXEMPLIFYING EMBODIMENTS

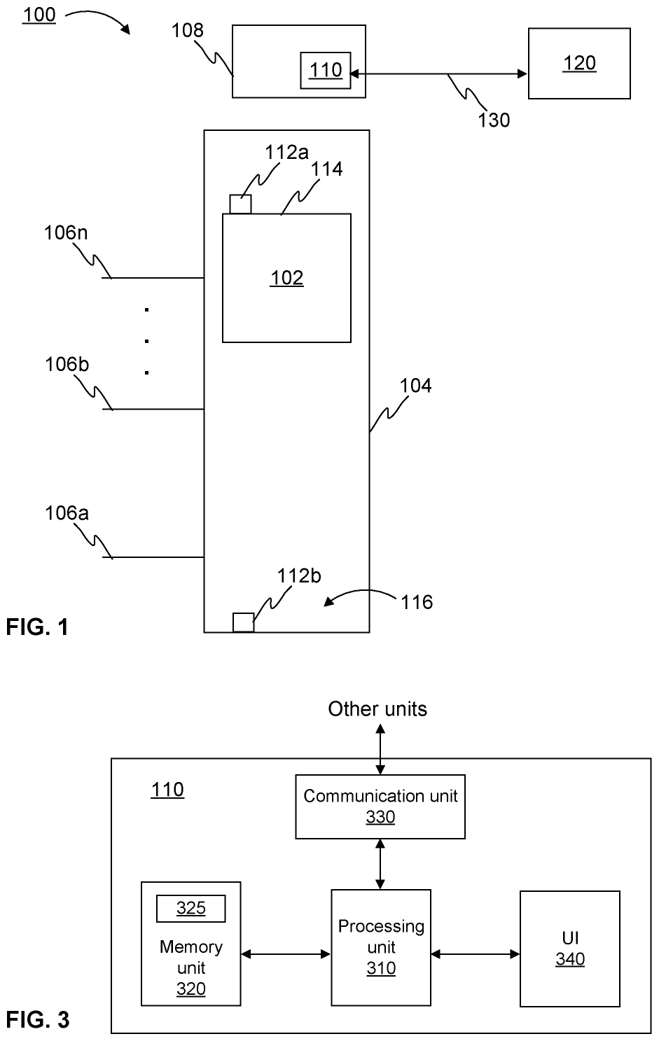

FIG. 1 illustrates schematically an example of an elevator system 100. The elevator system 100 comprises an elevator car 102 configured to travel along an elevator shaft 104 between a plurality of floors, i.e. landings, 106a-106n. The elevator system 100 further comprises an elevator control system 108 configured to control operations of the elevator system 100 at least in part. The elevator control system 108 may reside for example inside a machine room of the elevator system 100, which is not shown in FIG. 1 for sake of clarity. Alternatively, the elevator control system 108 may reside for example at one floor 106a-106n, e.g. at the top floor 106n, for example if the elevator system 100 is a machine-room-less elevator system. The elevator control system 108 may comprise a plurality of control units comprising for example, but not limited to, a main elevator control unit, a drive unit, an elevator safety control unit 110, and/or a car control unit. The elevator safety control unit 110 may be configured to fulfill special safety requirements according to elevator safety norms to reach a safety integrity level 3 (SIL3), which is a level required for safety devices of elevator systems. The elevator safety control unit 110 is communicatively coupled to at least one other unit of the elevator control system 108 and operates in co-operation with the at least one other unit of the elevator control system 108. The communication between the elevator safety control unit 110 and the at least one other unit of the elevator control system 108 may be based on one or more known communication technologies, either wired or wireless. The elevator system 100 further comprises an elevator safety detection system 112a, 112b for monitoring people, e.g. safety personnel such as a service technician, entering the elevator shaft 104. The elevator safety detection system 112a, 112b may be configured to detect if one or more people enter the elevator shaft 104. The elevator safety control unit 110 is communicatively coupled to elevator safety detection system 112a, 112b. The communication between the elevator safety control unit 110 and the elevator safety detection system 112a, 112b may be based on one or more known communication technologies, either wired or wireless. The elevator system 100 may further comprise one or more known elevator related entities, e.g. an elevator hoisting machinery, elevator ropes, safety circuit, an elevator door system, etc., which are not shown in FIG. 1 for sake of clarity.

The elevator system 100 may be associated with a remote elevator service entity 120. The remote elevator service entity 120 may for example be a remote service center. At least one unit of the elevator control system 108, e.g. at least the elevator safety control unit 110, may be communicatively coupled to the remote elevator service entity 120 for example via a remote communication link 130. The remote communication link 130 may be a secured communication link. The communication between the remote elevator service entity 120 and the at least one unit of the elevator control system 108, e.g. via the remote communication link 130, may be based on one or more known communication technologies, either wired or wireless. The elevator safety control unit 110, the elevator safety detection system 112a, 112b, and the remote elevator entity 120 may form a remote reset system for resetting a safety mode of an elevator system 100.

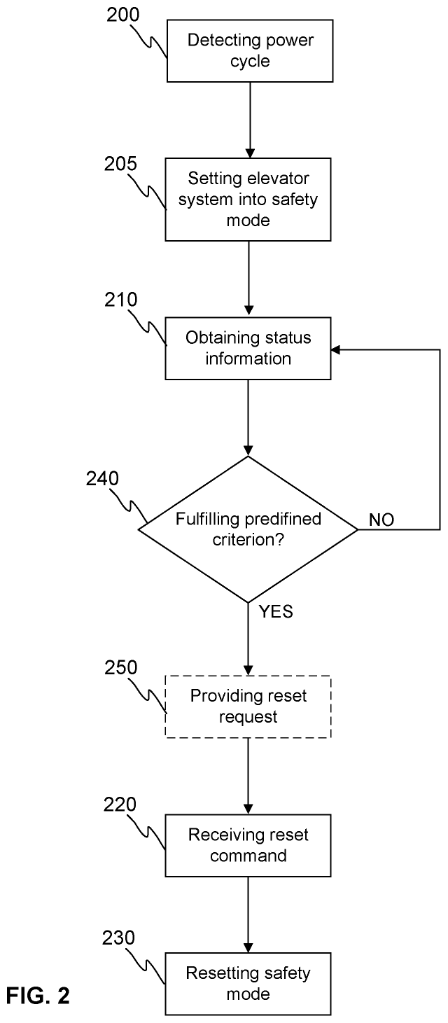

An example of a method for resetting a safety mode of an elevator system 100 is described by referring to FIG. 2, which illustrates the method as a flow chart. The safety mode of the elevator system 100 is caused by a power cycle of the elevator system 100. At a step 205, the elevator safety control unit 110 may be configured to set the elevator system 100 into the safety mode in response to detecting the power cycle of the elevator system 100 at a step 200. The power cycle of the elevator system 100 may comprise a sequence of power events. The sequence of the power events of the power cycle may comprise at least a power outage of the elevator system 100 and a restoration of a power supply of the elevator system 100 after the power outage of the elevator system 100. In other words, the elevator safety control unit 110 may be configured to set the elevator system 100 into the safety mode in response to detecting the sequence of power events comprising at least the power outage of the elevator system 100 and the restoration of the power supply of the elevator system 100 after the power outage of the elevator system 100. The sequence of the power events of the power cycle may further comprise an initial state before the power outage of the elevator system 100, where the power supply of the elevator system 100 is functioning before the power outage of the elevator system 100. Setting the elevator system 100 into the safety mode in response to detecting the power cycle of the elevator system 100 is a fail-safe feature of the elevator system 100, which improves the safety of the elevator system 100, because during the power outage the elevator safety detection system 112a, 112b is not able to monitor people entering the elevator shaft 104. When the elevator system 100 is in the safety mode, a normal operation of the elevator system 100 is prevented for safety reasons. With the term “normal operation of the elevator system” is meant throughout this application an operation of the elevator system 100 in which the elevator car 102 is serving users, e.g. passengers, of the elevator system 100 by transporting the users and/or load between the floors 106a-106n of the elevator system 100 under normal circumstances. The normal operation of the elevator system 100 does not include e.g. inspection, maintenance, and rescue modes/operations of the elevator system 100. When the elevator system 100 is in the safety mode, only a low-speed manual drive operation of the elevator car 102 is allowed. The low-speed manual drive operation of the elevator car 102 may be performed by service personnel e.g. a service technician, working inside the elevator shaft 104, through a manual user interface dedicated for the low-speed manual drive operation of the elevator car 102. The manual interface, e.g. an inspection drive unit, may be arranged for example inside the elevator shaft 104, to a rooftop 114 of the elevator car 102, or to a pit 116 of the elevator shaft 104.

The safety mode of the elevator system 100 may comprise a person-in-shaft safety mode or a safety space arrangement (SSA) safety mode. When the elevator system 100 is in the person-in-shaft safety mode at least one safety space, i.e. at least one safe working space, for service personnel inside the elevator shaft 104 are arranged. The at least one safety space may comprise at least one permanent safety space and/or at least one temporary safety space. When the elevator system 100 is in the SSA safety mode, the at least one temporary safety space for the service personnel may be arranged at least partially inside the elevator car 102. The SSA safety mode is especially beneficial in elevator systems where adequate safety space for service personnel inside the elevator shaft 104 cannot be arranged. For example, if the pit 116 of the elevator shaft 104 is not deep enough and/or safety buffers of the elevator car 102 and safety buffers of a counterweight arranged to the pit 116 of the elevator shaft 104 are not long enough. In the SSA safety mode the at least one temporary safety space may be arranged for the service personnel by using one or more assistive devices, e.g. turnable buffers, pre-triggered safety devices, a raisable, i.e. liftable roof of the elevator car 102, removable wall portions, etc.. The pre-triggered safety devices may for example comprise detents mechanically contacting a safety gear of the elevator car 102, when the elevator car 102 with the safety gear arrives at the detent. The one or more assistive devices may be arranged to form the at least one temporary safety spaces, when the one or more assistive devices are in an operating position. Before restoring the elevator system 100 from the SSA safety mode to the normal operation mode of the elevator system 100, the one or more assistive devices need to be arranged from the operating position to a retracted position, in which the at least one temporary safety space are removed. In the retracted position of the one or more assistive devices, the one or more assistive devices allow the elevator car 102 travel in its entire trajectory along the elevator shaft 104. For example, the pre-triggered safety devices may be turned into the operating position, i.e. an extracted position, when the service personnel enter the elevator shaft 104, to form the at least one temporary safety space. In case the elevator car 102 arrives at the pre-triggered safety device, it may activate the safety gear of the elevator car 102, which causes an immediate stopping of the elevator car 102. The position of the one or more assistive devices may be monitored for example with at least safety contact of the elevator safety detection system 112a, 112b.

At a step 210, upon the restoration of the power supply of the elevator system 100, the elevator safety control unit 110 obtains status information indicative of a current safety status of the at least one safety space of the elevator system 100. As discussed above, the power cycle causing the safety mode of the elevator system 100 comprises the restoration of the power supply of the elevator system 100 occurring after the power outage of the elevator system 100. Therefore, in other words, the elevator safety control unit 110 may obtain the status information after the power cycle. The elevator safety control unit 110 obtains the status information from the elevator safety detection system 112a, 112b. Each of the at least one safety space of the elevator system 100 may forms a refuge space for the service personnel to work (e.g. to perform one or more maintenance and/or inspection related operations of the elevator system 100) inside the elevator shaft 104. The at least one safety space of the elevator system 100 may comprise the elevator shaft 104, at least a predefined part of the elevator shaft 104, the pit 116 of the elevator shaft 104, and/or the rooftop 114 of the elevator car 102. The current safety status of the at least one safety space of the elevator system 100 may indicate whether one or more objects, e.g. service personnel, the one or more assistive devices, and/or any other object causing a safety risk, exist inside said at least one safety space of the elevator system 100. The elevator safety detection system 112a, 112b may comprise a plurality of detection devices 112a, 112b configured to provide the status information. In the example of FIG. 1 the elevator safety detection system 112a, 112b comprises one detection device 112a arranged to the rooftop 114 of the elevator car 102 and one detection device 112b arranged to the pit 116 of the elevator shaft 104. However, the elevator safety detection system 112a, 112b may comprise any other number of detection devices arranged to the elevator system 100. The plurality of detection devices of the elevator safety detection system 112a, 112b may comprise at least one imaging sensor device, at least one sensor device, and/or a plurality of safety contacts.

The at least one imaging sensor device may comprise e.g. an infrared camera, a closed-circuit-television (CCTV) camera, an optical camera, and/or any other imaging sensor device. The at least one imaging sensor device may be configured to provide status information from the elevator shaft 104 or from the predefined part of the elevator shaft 104, i.e. the status information, e.g. image data, indicative of the current safety status of the elevator shaft 104 or the predefined part of the elevator shaft 104. In other words, the status information provided by the at least one imaging sensor device may indicate whether one or more objects exist inside the elevator shaft 104 or inside the predefined part of the elevator shaft 104.

The at least one sensor device may comprise at least one three-dimensional (3D) sensor device arranged inside the elevator shaft 104 and/or at least one pressure sensor device arranged to a floor of the pit 116 of the elevator shaft 104 and/or to the rooftop 114 of the elevator car 102. The at least one pressure sensor device may be configured to provide status information from the pit 116 of the elevator shaft 104, i.e. the status information, e.g. pressure data, indicative of the current safety status of the pit 116 of the elevator shaft 104, and/or from the rooftop 114 of the elevator car 102, i.e. the status information, e.g. pressure data, indicative of the current safety status of the rooftop 114 of the elevator car 102. In other words, the status information provided by the at least one pressure sensor device may indicate whether one or more objects exist in the pit 116 of the elevator shaft 104 and/or on the rooftop 114 of the elevator car 102. The at least one 3D sensor may comprise e.g. a 3D camera, a 3D light curtain, a radar sensor device based on electromagnetic radiation (e.g. a Lidar), and/or any other sensor device configured to provide also depth data of a monitored volume, e.g. 3D data from the at least one safety space of the elevator system 100. The at least on 3D sensor device may be configured to provide the status information from the elevator shaft 104 or from the predefined part of the elevator shaft 104, i.e. the status information, e.g. 3D data, indicative of the current safety status of the elevator shaft 104 or the predefined part of the elevator shaft 104. In other words, the status information provided by the at least one 3D sensor device may indicate whether one or more objects exist inside the elevator shaft 104 or inside the predefined part of the elevator shaft 104.

The plurality of safety contacts may comprise for example, but is not limited to, at least one safety contact for a door allowing access to the pit 116 of the elevator shaft 104, at least one safety contact for door allowing access to the rooftop 114 of the elevator car 102, at least one safety contact for an emergency exit door, e.g. a trap door, allowing access from the elevator car 102 to the roof top 114 of the elevator car 102, at least one safety contact for the one or more assistive devices, at least one safety contact for any other safety related operation and/or safety related device of the pit 116 of the elevator shaft 104, and/or at least one safety contact for any other safety related operation and/or safety related device of the rooftop 114 of the elevator car 102. The plurality of safety contacts may be configured to provide the status information from the pit 116 of the elevator shaft 104, i.e. the status information indicative of the current status of the pit 116 of the elevator shaft 104, and/or from the rooftop 114 of the elevator car 102, i.e. the status information indicative of the current status of the rooftop 114 of the elevator car 102. The status information provided by the plurality of safety contacts may comprise information indicating whether each safety contact belonging to the plurality of safety contacts is open or closed. In case a safety contact belonging to the plurality of safety contacts is open, the status information may indicate that one or more objects may exist inside the respective at least one safety space of the elevator system 100. In case a safety contact belonging to the plurality of safety contacts is closed, the status information may indicate that no object exists inside the respective at least one safety space of the elevator system. In other words, if status information provided by at least one of the plurality of safety contacts comprises information indicating that said safety contact is open, the current safety status indicates that one or more objects may exist inside the respective at least one safety space of the elevator system 100. Alternatively, if status information provided by at least one of the plurality of safety contacts comprises information indicating that said safety contact is closed, the current safety status indicates that no object exists inside the respective at least one safety space of the elevator system 100.

At a step 220, the elevator safety control unit 110 receives from the remote elevator service entity 120 a reset command comprising an instruction to reset the safety mode of the elevator system 100. The elevator safety control unit 110 may receive the reset command from the elevator service entity 120 via the remote communication link 130. The reset command may be a manual reset command issued manually in the remote elevator service entity 120.

At a step 230, the elevator safety control unit 110 resets the safety mode of the elevator system 110 in response to receiving the reset command from the remote elevator service entity 120, if the obtained status information fulfills a predefined criterion at a step 240. The predefined criterion may comprise that the at least one safety space of the elevator system 100 being empty. The term “being empty” in the context of the at least one safety space of the elevator system 100 means that the at least one safety space of the elevator system 100 is unmanned and does not contain any object causing a safety risk, i.e. no objects exist inside said at least one safety space of the elevator system 100. As discussed above, the at least one safety space of the elevator system 100 may comprise the elevator shaft 104, at least the predefined part of the elevator shaft 104, the pit 116 of the elevator shaft 104, the rooftop 114 of the elevator car 102. Therefore, the predefined criterion may comprise that the elevator shaft 104 is empty, at least the predefined part of the elevator shaft 104 is empty, the pit 116 of the elevator shaft 104 is empty, and/or the rooftop 114 of the elevator car 102 is empty. If the obtained status information obtained from each detection device of the elevator safety detection system 112a, 112b indicates that the at least one safety space of the elevator system 100 is empty, the obtained status information is determined to fulfil the predefined criterion. However, if the status information obtained from at least one detection device of the elevator safety detection system 112a, 112b indicates that at least one safety space of the elevator system 100 is not empty, the obtained status information is not determined to fulfil the predefined criterion.

Next a non-limiting example of the method described above is presented, wherein the elevator system 100 is set into the safety mode, by the elevator safety control unit 110, in response to detecting the power cycle of the elevator system 100. In this example, the elevator safety detection system 112a, 112b comprises the following detection devices: an imaging sensor device, e.g. an optical camera, configured to provide status information from the elevator shaft 104, at least one safety contact configured to provide status information from the pit 116 of the elevator shaft 104, and at least one safety contact configured to provide status information from the rooftop 114 of the elevator car 102. In other words, in this example the status information comprises status information indicative of the current safety status of the elevator shaft 104, status information indicative of the current safety status of the pit 116 of the elevator shaft 104, and status information indicative of the current safety status of the rooftop 114 of the elevator car 102. Thus, in this example the at least one safety space of the elevator system 100 comprises the elevator shaft 104, the pit 116 of the elevator shaft 104, and the rooftop 114 of the elevator car 102. Furthermore, in this example the predefined criterion is that the at least one safety space of the elevator system 100 is empty. The elevator safety control unit 110 obtains the status information from the elevator safety detection system 112a, 112b at the step 210 as described above. The elevator safety control unit 110 determines at the step 240 whether the obtained status information fulfils the predefined criterion as described above. In other words, the elevator safety control unit 110 determines based on the obtained status information whether the at least one safety space of the elevator system 100 is empty. If the elevator safety control unit 110 determines that the obtained status information fulfils the predefined criterion, the elevator safety control unit 110 resets the safety mode of the elevator system 100 at the step 230 in response to receiving the reset command from the remote elevator service entity 120 at the step 220 as described above. In other words, if the elevator safety control unit 110 determines that the status information obtained from each detection device of the elevator safety detection system 112a, 112b indicates that the at least one safety space of the elevator system 100 is empty, the elevator safety control unit 110 resets the safety mode of the elevator system 100 in response to receiving the reset command from the remote elevator service entity 120. However, if the elevator safety control unit 110 determines at the step 240 that the status information obtained from at least one detection device of the elevator safety detection system 112a, 112b indicates that at least one safety space of the at least one safety space of the elevator system 100 is not empty, the elevator safety control unit 110 does not reset the safety mode of the elevator system 100, even if the elevator safety control unit 110 receives the reset command from the remote elevator service entity 120 at the step 220, because the predefined condition is not fulfilled.

The resetting the safety mode of the elevator system 100 at the step 230 may comprise turning the elevator system 100 from the safety mode into a limited operational mode of the elevator system 100. In the limited operation mode of the elevator system 100 at least a limited operation of the elevator system 100 is allowed. In the limited operational mode of the elevator system 100 the movement of the elevator car 102 to the top floor 106n, the bottom floor 106a and/or at least one other floor 106a-106n may be prevented. The limited operational mode of the elevator system 100 may for example depend on the safety space configuration of the elevator system 100. For example, if the safety space, either permanent or temporary, of the elevator system 100 is arranged to the rooftop 114 of the elevator car 102, in the limited operation mode of the elevator system 100 the movement of the elevator car 102 to the top floor 106n may be prevented. According to another example, if the temporary safety space, either permanent or temporary, of the elevator system 100 is arranged to the pit 116 of the elevator shaft 104, in the limited operation mode of the elevator system 100 the movement of the elevator car 102 to the bottom floor 106a may be prevented. According to yet another example, if the safety mode of the elevator system 100 is the SSA safety mode, the movement of the elevator car 102 may be limited for example so that for example a minimum of one floor distance temporary safety space may be temporarily created.

According to an example, the elevator safety control unit 110 may provide to the remote elevator service entity 120 a reset request at a step 250 (illustrated with the dashed line in FIG. 2), in response to determining that the obtained status information fulfills the predefined criterion at the step 240. In that case the elevator safety control unit 110 may receive the reset command from the remote elevator service entity 120 at the step 230, in response to providing the reset request to the remote elevator service entity 120. In other words, the elevator safety control unit 110 may determine after obtaining the status information whether the obtained status information fulfills the predefined criterion at the step 240. In response to the determination that the obtained status information fulfills the predefined criterion at the step 240, the elevator safety control unit 110 may provide to the remote elevator service entity 120 the reset request at the step 250. The remote elevator service entity 120 may generate the reset command for the elevator safety control unit 110, in response to receiving the reset request from the elevator safety control unit 110. The reset request may comprise the status information obtained from the elevator safety detection system 112a, 112b. Alternatively, the reset request may be complemented with the status information obtained from the elevator safety detection system 112a, 112b. These enable providing to the remote elevator service entity 120 information about the current safety status of the at least one safety space of the elevator system 100, which in turn improves the safety of the elevator system 100.

In order to return the elevator system 100 from the limited operational mode into the normal operation of the elevator system 100 a manual reset may be required. In other words, the service personnel need to perform the manual reset via an operating interface to recover the elevator system 100 from the limited operation mode. Only after the manual reset, the normal operation of the elevator system 100 may be restored. The operating interface may be a manual switch or a manual button disposed in an elevator control cabinet located outside the elevator shaft 104. The elevator control cabinet may be located inside the machine room of the elevator system 100. If the elevator system 100 is a machine-room-less elevator system, the elevator control cabinet may be located at the top floor 106n, e.g. next to a landing door frame at the top floor 106n.

FIG. 3 illustrates schematically an example of components of the elevator safety control unit 110. The elevator safety control unit 110 may comprise a processing unit 310 comprising at least one processor, a memory unit 320 comprising at least one memory, a communication unit 330 comprising at least one communication device, and possibly a user interface (UI) unit 330. The mentioned elements may be communicatively coupled to each other with e.g. an internal bus. The memory unit 320 may store and maintain portions of a computer program (code) 325, the obtained status information, and any other data. The computer program 325 may comprise instructions which, when the computer program 325 is executed by the processing unit 310 of the elevator safety control unit 110 may cause the processing unit 310, and thus the elevator safety control unit 110 to carry out desired tasks, e.g. one or more of the method steps described above and/or the operations of the elevator safety control unit 110 described above. The processing unit 310 may thus be arranged to access the memory unit 320 and retrieve and store any information therefrom and thereto. For sake of clarity, the processor herein refers to any unit suitable for processing information and control the operation of the elevator safety control unit 110, among other tasks. The operations may also be implemented with a microcontroller solution with embedded software. Similarly, the memory unit 320 is not limited to a certain type of memory only, but any memory type suitable for storing the described pieces of information may be applied in the context of the present invention. The communication unit 330 provides one or more communication interfaces for communication with any other unit, e.g. the remote service unit 120, one or more other units of the elevator control system 108, the elevator safety detection system 112a, 112b, one or more databases, or with any other unit. The user interface unit 340 may comprise one or more input/output (I/O) devices, such as buttons, keyboard, touch screen, microphone, loudspeaker, display and so on, for receiving user input and outputting information. The computer program 325 may be a computer program product that may be comprised in a tangible nonvolatile (non-transitory) computer-readable medium bearing the computer program code 325 embodied therein for use with a computer, i.e. the elevator safety control unit 110.

The method, the remote reset system, and the elevator safety control unit 110 discussed above allow a restoration of the elevator system 100 from a safety mode remotely after a power cycle of the elevator system 100 that caused the elevator system 100 turning into the safety mode. Furthermore, the method, the remote reset system, and the elevator safety control unit 110 discussed above enable that entrapment situations may be avoided and a manual evacuation of the passengers of the elevator car 102 is not needed. These enable that the downtime of the elevator system 100 may be decreased, and the elevator service may be improved.

The specific examples provided in the description given above should not be construed as limiting the applicability and/or the interpretation of the appended claims. Lists and groups of examples provided in the description given above are not exhaustive unless otherwise explicitly stated.

1. A method for resetting a safety mode of an elevator system, wherein the safety mode is caused by a power cycle of the elevator system, the method comprising:
obtaining, upon a restoration of a power supply of the elevator system, status information indicative of a current safety status of at least one safety space of the elevator system from an elevator safety detection system;
receiving, from a remote elevator service entity, a reset command comprising an instruction to reset the safety mode of the elevator system; and
resetting the safety mode of the elevator system in response to receiving the reset command, if the obtained status information fulfills a predefined criterion.

2. The method according to claim 1, wherein the resetting the safety mode of the elevator system comprises turning the elevator system from the safety mode into a limited operational mode, in which at least a limited operation of the elevator system is allowed.

3. The method according to claim 2, wherein in the limited operational mode a movement of an elevator car of the elevator system to a top floor, a bottom floor, and/or at least one other floor is prevented.

4. The method according to claim 1, comprising:
providing to the remote elevator service entity a reset request in response to determining that the obtained status information fulfills the predefined criterion, and
receiving from the remote elevator service entity the reset command, in response to providing the reset request to the remote elevator service entity.

5. The method according to claim 4, wherein the reset request comprises or is complemented with the status information obtained from the elevator safety detection system.

6. The method according to claim 1, wherein the elevator safety detection system comprises at least one imaging sensor device, at least sensor device, and/or a plurality of safety contacts.

7. The method according to claim 1, wherein the reset command is a manual reset command issued manually in the remote elevator service entity.

8. The method according to claim 1, wherein the safety mode of the elevator system comprises a person-in-shaft safety mode or a safety space arrangement safety mode.

9. The method according to claim 1, wherein the predefined criterion comprises that the at least one safety space of the elevator system is empty.

10. The method according to claim 1, wherein the power cycle comprises a sequence of power events, wherein the sequence of the power events comprises at least a power outage of the elevator system and the restoration of the power supply of the elevator system after the power outage.

11. The method according to claim 1, comprising setting the elevator system into the safety mode in response to detecting the power cycle of the elevator system.

12. An elevator safety control unit for resetting a safety mode of an elevator system, wherein the safety mode is caused by a power cycle of the elevator system, the elevator safety control unit comprising:
a processing unit comprising at least one processor; and
a memory unit comprising at least one memory including computer program code;
wherein the at least one memory and the computer program code are configured to, with the at least one processor, cause the elevator safety control unit to perform:
obtain, upon a restoration of a power supply of the elevator system, status information indicative of a current safety status of at least one safety space of the elevator system from an elevator safety detection system;
receive, from a remote elevator service entity, a reset command comprising an instruction to reset the safety mode of the elevator system; and
reset the safety mode of the elevator system in response to receiving the reset command, if the obtained status information fulfills a predefined criterion.

13. A remote reset system for resetting a safety mode of an elevator system, wherein the safety mode is caused by a power cycle of the elevator system, the system comprising:
an elevator safety detection system,
a remote elevator service entity, and
an elevator safety control unit according to claim 12.

14. A computer program comprising instructions which, when the program is executed by a computer, cause the computer to carry out the method claim 1.

15. A computer-readable storage medium comprising instructions which, when executed by a computer, cause the computer to carry out the method according to claim 1.

16. The method according to claim 2, comprising:
Providing to the remote elevator service entity a reset request in response to determining that the obtained status information fulfills the predefined criterion, and
receiving from the remote elevator service entity the reset command, in response to providing the reset request to the remote elevator service entity.

17. The method according to claim 3, comprising:
Providing to the remote elevator service entity a reset request in response to determining that the obtained status information fulfills the predefined criterion, and
receiving from the remote elevator service entity the reset command, in response to providing the reset request to the remote elevator service entity.

18. The method according to claim 2, wherein the elevator safety detection system comprises at least one imaging sensor device, at least sensor device, and/or a plurality of safety contacts.

19. The method according to claim 3, wherein the elevator safety detection system comprises at least one imaging sensor device, at least sensor device, and/or a plurality of safety contacts.

20. The method according to claim 4, wherein the elevator safety detection system comprises at least one imaging sensor device, at least sensor device, and/or a plurality of safety contacts.
